(19) United States
(12) Patent Application Publication
(10) Pub. No.: US 2022/0048532 A1
(43) Pub. Date: Feb. 17, 2022

(54) MOTOR VEHICLE GATE PASSING ASSISTANCE SYSTEM AND METHOD

(71) Applicant: FORD GLOBAL TECHNOLOGIES, LLC, DEARBORN, MI (US)

(72) Inventor: Frederic Stefan, Aachen (DE)

(21) Appl. No.: 17/370,261

(22) Filed: Jul. 8, 2021

(30) Foreign Application Priority Data
Aug. 11, 2020 (DE) 102020121139.2

(51) Int. Cl. B60W 60/00; B60W 30/18; B60W 50/14; G07C 9/10

(52) U.S. Cl. CPC B60W 60/001; G07C 9/10; B60W 50/14; B60W 30/18109

(57) ABSTRACT

A motor vehicle (2) is operated in conjunction with a barrier assembly (e.g., a passing gate). After reading an environment data record (UDS) from environment sensors (14) of the motor vehicle (2), the environment data record (UDS) is evaluated for an approach to a barrier assembly (4). A stopping data record (SDS) is determined which is indicative of a stopping position of the motor vehicle (2) in front of the barrier assembly (4). An interaction data record (IDS) associated with the barrier is determined which is indicative of an interaction with the barrier assembly (4) such as opening a driver window.

### CROSS REFERENCE TO RELATED APPLICATIONS

This application claims priority to application 102020121139.2, filed in the German Patent and Trademark Office on Aug. 11, 2020, which is incorporated herein by reference in its entirety.

### STATEMENT REGARDING FEDERALLY SPONSORED RESEARCH

Not Applicable.

### BACKGROUND OF THE INVENTION

The present invention relates in general to a method for the operation of a motor vehicle in the vicinity of a passing gate, and, more specifically, to operating motor vehicles in situations when it is necessary to pass through a movable barrier of a barrier assembly in order to gain access to a restricted area, such as parking spaces, car parks, or toll road sections.

Such a barrier assembly with a barrier also has an opening device for lifting or otherwise moving the barrier to allow the motor vehicle to pass. In order for the opening device to clear the way by raising the barrier, an interaction between the motor vehicle and/or the driver of the motor vehicle with the opening device may be necessary. This interaction may include, for example, transferring an access code, pressing a button, removing a ticket, speaking or paying a parking fee or a toll, for example.

Passing such a barrier assembly may seem simple, but often requires many separate actions on the part of the driver of the motor vehicle. The trajectory of the vehicle must be chosen in such a way that it travels on an often narrow path and comes to a stop in front of the barrier. During this process, the driver must take care not to stop the motor vehicle too far away from the opening device, otherwise it is not possible to interact with an HMI or payment terminal of the opening device for example, without the driver having to exit from the motor vehicle or to back-up to correct the position of the motor vehicle. During the approach maneuver, the driver may have to prepare for interaction with the opening device, which may include holding an access card or operating the payment terminal. At the end of the maneuver, the driver often has to open a driver-side side window to interact with the opening system.

The entire driving maneuver must not take up excessive time to avoid a queue or the annoyance of other road users. Depending on the traffic situation, the entire driving maneuver can also be stressful for the drivers, as the driving maneuver must be carried out in a narrow environment and there is an increased risk of collision.

Known systems which are intended to support the driver in this situation are disclosed in patent publications US2017/0228717A1, CN106781688A, US2019/0164357A1, KR100832697B1, and US 2019/0221048A1, for example.

However, there is a need to further reduce the load on a driver in such situations.

### SUMMARY OF THE INVENTION

The object of further reducing the driver load is achieved by a method for the operation of a motor vehicle which comprises collecting/reading an environment data record from environment sensors of the motor vehicle. The environment data record is evaluated to detect an approach to a barrier assembly having an interface device. A stopping data record is determined comprised of a stopping position of the motor vehicle and a trajectory data record (e.g., vehicle maneuvers) defining a trajectory from a current position of the motor vehicle to the stopping position, wherein the stopping position is configured to enable an interaction with the interface device. An automatic action is executed during the approach to the barrier assembly to facilitate access to the passing gate, wherein the action is determined according to an interaction data record corresponding to the detected barrier assembly.

Preferably, data are used which are collected by already existing environment sensors of the motor vehicle and the vehicle can be stopped semi-autonomously or fully autonomously using the stopping data record indicative of the stopping position and thus the load on the driver is reduced.

According to one embodiment, an interaction data record is determined which is indicative of an interaction of the motor vehicle and/or a driver of the motor vehicle with the barrier assembly. The interaction data record, which is indicative of an interaction can determine whether, for example, a transfer of an access code, pressing a button, removing a ticket, speaking, or paying a parking fee or a toll are necessary to gain access to an area with restricted access authorization. Further information is therefore available relating to necessary actions required after the vehicle has stopped in front of the barrier assembly in order to gain access to an area with limited access. Thus, the vehicle can be prepared for the following interaction, in particular on the basis of the interaction data record, for example by opening a driver-side side window so that a driver can interact more easily with the barrier opening system.

According to a further embodiment, a trajectory data record is determined which is indicative of a trajectory from a current position of the motor vehicle to the specific stopping position. The trajectory data record for a trajectory thus describes the path from the current position of the motor vehicle to the specific stopping position. Thus, the motor vehicle can be controlled semi-autonomously or fully autonomously up to the stopping position, in particular on the basis of steering commands, throttle commands, and braking commands determined on the basis of the trajectory data record.

According to a further embodiment, a control record is determined for controlling the motor vehicle according to the trajectory data record from the current position of the motor vehicle to the specific stopping position. Steering commands are therefore determined in order to control the motor vehicle semi-autonomously or fully autonomously up to the stopping position. In this way, the driver loading is further reduced.

According to a further embodiment, the interaction is carried out according to the interaction data record which is indicative of an interaction of the motor vehicle and/or a driver of the motor vehicle with the barrier assembly. The driver loading is thus reduced still further.

Furthermore, the invention may include a computer program product, a control unit, and a motor vehicle with such a control unit.

### BRIEF DESCRIPTION OF THE DRAWINGS

FIG. 1 shows in a schematic representation a motor vehicle approaching a barrier assembly.

FIG. 2 shows in a schematic representation, inter alia, components of the motor vehicle shown in FIG. 1.

FIG. 3 shows a flowchart for the operation of the motor vehicle shown in FIG. 1.

### DETAILED DESCRIPTION OF PREFERRED EMBODIMENTS

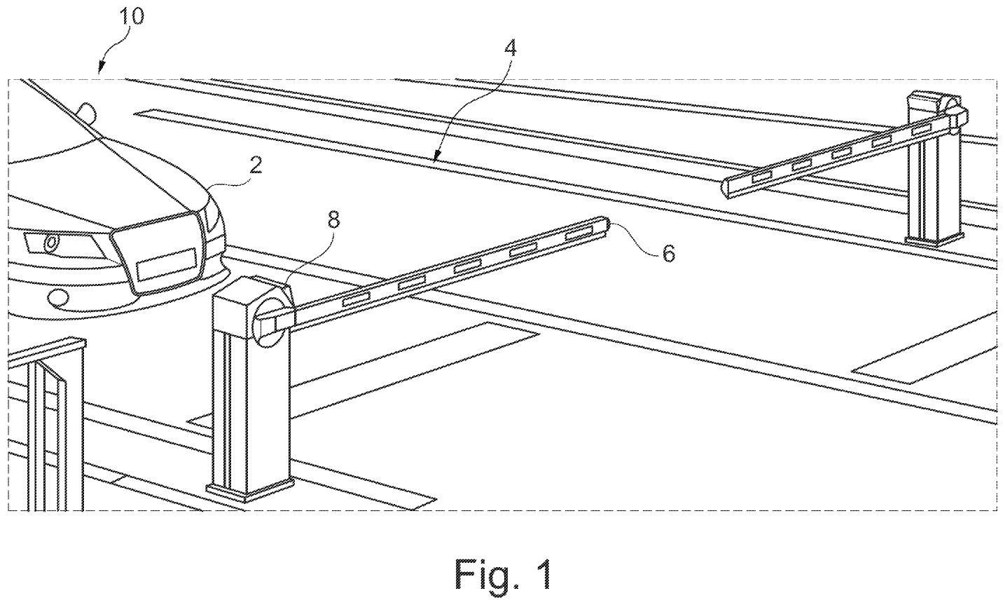

In FIG. 1, a scenario is presented in which a motor vehicle 2 approaches a barrier 6 of a barrier assembly 4.

By an interaction between the motor vehicle 2 and/or the driver 10 of the motor vehicle 2 and an opening device 8 for opening the barrier 6, it can be opened so that motor vehicle 2 will have access to an area with limited access, such as parking spaces or car parks, or to toll road sections.

The motor vehicle 2 is a car in the present embodiment. However, it may also be another motor vehicle 2, such as a truck.

The motor vehicle 2 may have one or more driving assistance systems or may be in the form of a self-driving motor vehicle 2.

Advanced driver assistance systems (ADAS) are auxiliary electronic devices in motor vehicles 2 for assisting a driver 10 in certain driving situations. Safety aspects are often the main focus, but ADAS can also provide an increase in driving comfort. Such driver assistance systems read and evaluate environment data records from environment sensors.

A self-driving motor vehicle 2 (sometimes also an autonomous land vehicle) describes a car or other motor vehicle that can drive, control, and park without the influence of a human driver. In the event that no manual control is required by the driver 10, the term robot car is also used. Then the driver's seat can remain empty; and a steering wheel, brake, and accelerator pedal may not be present. Self-driving vehicles 2 can also use various environment sensors to detect their surroundings and to determine their own position and that of other road users from the environment data record which is obtained. In cooperation with the navigation software, they can navigate to a driving destination and avoid collisions along the way there.

Thus, in the present exemplary embodiment, the motor vehicle 2 at least meets the SAE autonomy level 1 according to SAE J3016. However, it can also be a motor vehicle 2 according to one of the SAE autonomy levels 2 to 5 in SAE J3016.

Passing the barrier assembly 4 seems to be trouble-free but may often require many actions on the part of the driver 10 of the motor vehicle 2.

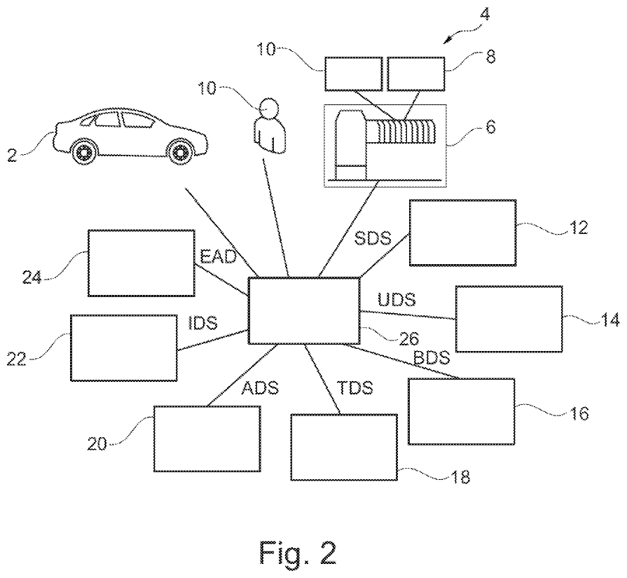

In order to relieve the load on the driver 10 in this case, the motor vehicle 2 has the components shown in FIG. 2, which are designed to be semi-autonomous or fully autonomous, e.g., for assisting the driver 10 or for passing the barrier assembly 4 without a driver intervention.

For this purpose, the motor vehicle 2 and/or the components shown in FIG. 2 have hardware and/or software components for the tasks and/or functions described below.

The components shown are a barrier detection module 12, environment sensors 14, a vehicle monitoring module 16, a trajectory planning module 18, a vehicle control module 20, an interaction module 22, an HMI 24, and a control unit 26.

The barrier detection module 12 is designed for the detection of a barrier assembly 4 coincident with the path of the motor vehicle 2 and provides a stopping position record SDS. The detection may be based on a manual input of the driver 10, for example by means of the HMI 24, and/or on the navigation data of the motor vehicle 2 (GPS and map data), and/or on a programmed route of the motor vehicle 2. The detection may also be alternatively or additionally based on evaluation of the environment data record UDS, which is provided by environment sensors 14 of the motor vehicle 2.

The environment sensors 14 are designed to monitor traffic in front of the vehicle 2 and in particular a distance to a foremost (i.e., leading) object or road user and the speed of the foremost object. The environment sensors 14 can be for example radar, LIDAR, ultrasonic sensors, or camera systems. Vehicle-to-everything (V2X) systems can also provide the environment data record UDS. V2X systems may include vehicle-to-vehicle (V2V), vehicle-to-road (V2R), vehicle-to-infrastructure (V2I), vehicle-to-network (V2N), and vehicle-to-person (V2P) communications.

The vehicle monitoring module 16 is equipped to monitor the condition of the motor vehicle 2, for example its odometry, speed, the distance travelled, and/or a yaw/steering angle, and to provide an operating data record BDS. This can be achieved with the help of sensors belonging to the vehicle and/or information available via control units and/or CAN bus signals of the motor vehicle 2. In addition, a condition assessment by means of Kalman filters can be used.

The trajectory planning module 18 is designed to determine a trajectory data record TDS from a current position of the motor vehicle 2 up to the specific stopping position in conjunction with a gate or barrier.

For this purpose, the trajectory planning module 18 is designed to detect a barrier assembly 4 or to read in data of the barrier detection module 12.

Furthermore, the trajectory planning module 18 is designed to determine a position or position data indicative of a position of the detected barrier assembly 2. This can be a stopping position, for example 1 meter in front of the barrier 6. Furthermore, the trajectory planning module 18 is designed to determine a corresponding trajectory or a trajectory data record TDS based on the current position and the specific stopping position and to provide it in the form of the trajectory data record TDS. For this purpose, a navigation system of the motor vehicle 2 can be incorporated.

The vehicle control module 20 is designed to control longitudinal movements (fuel, brake, transmission) and transverse movements of the motor vehicle 2. Furthermore, the vehicle control module 20 is designed to determine a control data record ADS based on the trajectory data record TDS, which includes values for example for vehicle speed and steering setpoints, e.g., control signals for engine and steering interventions. For this purpose, other driving assistance systems such as a parking assistant, a traffic jam assistant, or cruise control can be incorporated.

The interaction module 22 is designed to support interactions of the motor vehicle 2 and/or the driver 10 with the barrier assembly 4, which is activated when necessary. It provides an interaction data record IDS.

For example, the interaction module 22 can cause the opening and later closing of the side window on the driver's side of the motor vehicle 2, because opening the side window allows the driver 10 to perform actions at a terminal, such as to receive a card, to perform a payment process, or even to speak.

Also, the interaction module 22 can activate an automatic payment system which uses credit cards, and which is implemented in the motor vehicle 2.

Furthermore, the interaction module 22 can also interact with a garage door opener system. Finally, the interaction module 22 can also interact with a vehicle identification system.

The HMI 24 (“Human Machine Interface”) is designed to enable the driver 10 to enter inputs and to receive feedback and notifications. The HMI 24 provides an input and output data record EAD and may be designed to output acoustic and/or optical and/or haptic signals. Furthermore, the HMI 24 may be designed for voice control or may provide buttons for the driver 10.

The control unit 26 is essential for the control of the method and coordinates the interaction and data exchange between the other components mentioned.

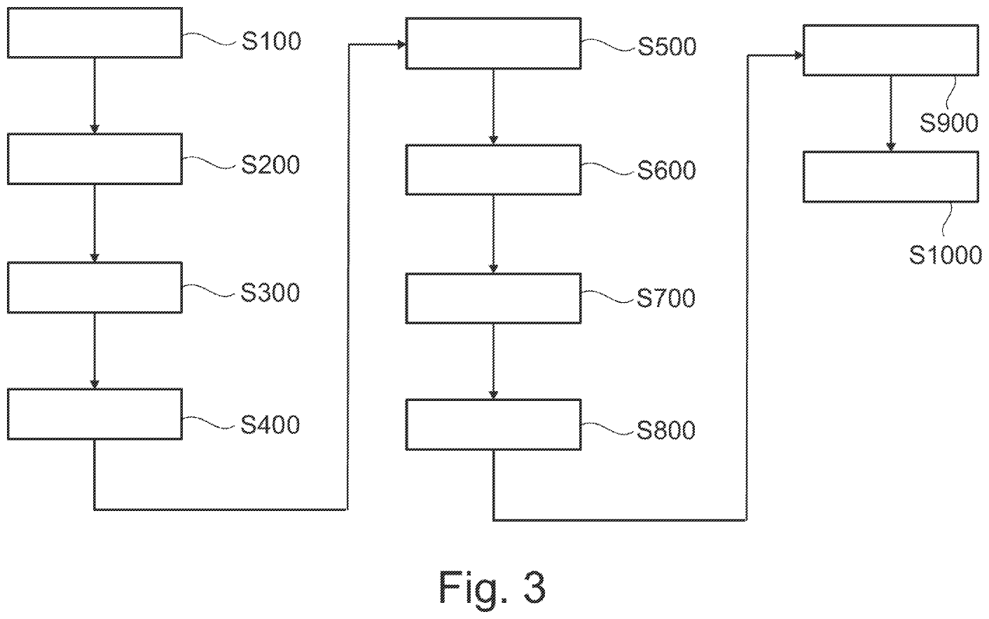

A procedure is now explained with additional reference to FIG. 3. The starting point is that the motor vehicle 2 with the driver 10 initially moves along a predetermined route at a certain speed. The route may be stored in a navigation system of the motor vehicle 2. A driving assistance system may be active which controls the motor vehicle 2 in whole or in part. This driving assistance system can be overridden if necessary.

In a first step S100, the environment data record UDS is read in from environment sensors 14 of the motor vehicle 2.

In a further step S200, the environment data record UDS is evaluated for an approach to a barrier module 4 by the barrier detection module 12. For example, 1000 meters in the direction of travel is monitored and evaluated. The result is provided by the barrier detection module 12 in the form of the stopping data record SDS. Furthermore, the barrier assembly 4 can also be activated by the driver 10.

In a further step S300, the trajectory planning module 18 is activated. The trajectory planning module 18 determines the trajectory data record TDS, inter alia with setpoints in the longitudinal direction and additionally in the transverse direction for stopping the motor vehicle 2 at the detected barrier assembly 4.

In a further step S400, a control data record ADS is determined by the vehicle control module 20 for controlling the motor vehicle 2 from the current position of the vehicle 2 to the specific stopping position according to the trajectory data record TDS. For this purpose, longitudinal and transverse guidance setpoints for the vehicle control module 20 and actual values provided by the vehicle monitoring module 16 are taken into account. The resulting control data record ADS can be acted upon by an autonomous vehicle controller for autonomous or semi-autonomous driving or can be provided to a human driver for guidance (e.g., via the HMI).

In step S500, the interaction module 22 is activated and provides the interaction data record IDS, for example for opening the side window on the driver's side of the vehicle 2.

If the motor vehicle 2 is located directly in front of the barrier 6, for example one meter from the barrier 6, the method is continued with a further step S600. It may also be provided that the interaction module 22 handles an interaction with the barrier module 4, such as a cashless payment process, automatically, i.e. without driver intervention. In this case, it may be provided that the motor vehicle 2 does not stop completely but passes the barrier assembly 4 at a reduced speed.

In a further step S600, the motor vehicle stops or slows in front of the barrier assembly 4. Now the driver 10 can perform the required interaction, for example through the open side window. In addition, the HMI 24 may require the driver to perform the required interaction, for example by means of acoustic and/or optical and/or haptic signals, according to the input and output data record EAD.

In addition, a start-stop system of the motor vehicle 2 can be controlled in order to automatically stop the internal combustion engine of the motor vehicle 2 during the interaction and thus save fuel.

In a further step S700, the driver 10 now performs the interaction with the barrier assembly 4.

In a further step S800, the opening device 8 of the barrier assembly 4 causes the barrier 6 to open.

Then, in a further step 900, the motor vehicle 2 passes the barrier 6.

Upon reaching a predetermined minimum distance from the barrier assembly or after the expiry of a predetermined period of time or exceeding a predetermined minimum speed, the method returns to the first step S100 in a further step S1000.

In a departure from the present exemplary embodiment, the order of the steps may also be different. In addition, multiple steps can also be performed at the same time or simultaneously. Furthermore, in a departure from the present exemplary embodiment, individual steps can be skipped or omitted.

The load on the driver 10 can thus be reduced when passing such a barrier assembly 4.

What is claimed is:

1. A method for operating a motor vehicle in conjunction with a barrier assembly, comprising the steps of:
collecting an environment data record from environment sensors of the motor vehicle;
evaluating the environment data record to detect an approach to the barrier assembly, wherein the barrier assembly has an interface device;
determining a stopping data record comprised of a stopping position of the motor vehicle and a trajectory data record defining a trajectory from a current position of the motor vehicle to the stopping position, wherein the stopping position is configured to enable an interaction with the interface device; and
executing an automatic action during the approach to the barrier assembly to facilitate access to the barrier assembly, wherein the action is determined according to an interaction data record corresponding to the detected barrier assembly.

2. The method of claim 1 further comprising the step of driving the motor vehicle autonomously on the trajectory to stop at the stopping position according to a control data record for controlling the motor vehicle from a current position of the motor vehicle to the stopping position.

3. The method of claim 1 wherein the automatic action specified by the interaction data record is comprised of opening a window of the motor vehicle facilitating interaction by an occupant of the motor vehicle with the interface device of the barrier assembly.

4. The method of claim 1 wherein the automatic action specified by the interaction data record is comprised of transferring an access code to the barrier assembly.

5. The method of claim 1 wherein the automatic action is executed at the stopping position.

6. The method of claim 1 wherein the automatic action is executed during movement in a vicinity of the barrier assembly.

7. A non-transitory computer readable media for operating a motor vehicle in conjunction with a barrier assembly, the non-transitory computer readable media, when read by one or more processors, configured to direct operations comprising:
collecting an environment data record from environment sensors of the motor vehicle;
evaluating the environment data record to detect an approach to the barrier assembly, wherein the barrier assembly has an interface device;
determining a stopping data record comprised of a stopping position of the motor vehicle and a trajectory data record defining a trajectory from a current position of the motor vehicle to the stopping position, wherein the stopping position is configured to enable an interaction with the interface device; and
executing an automatic action during the approach to the barrier assembly to facilitate access to the barrier assembly, wherein the action is determined according to an interaction data record corresponding to the detected barrier assembly.

8. The non-transitory computer readable media of claim 7 wherein the operations further comprise:
driving the motor vehicle autonomously on the trajectory to stop at the stopping position according to a control data record for controlling the motor vehicle from a current position of the motor vehicle to the stopping position.

9. The non-transitory computer readable media of claim 7 wherein the automatic action specified by the interaction data record is comprised of opening a window of the motor vehicle facilitating interaction by an occupant of the motor vehicle with the interface device of the barrier assembly.

10. The non-transitory computer readable media of claim 7 wherein the automatic action specified by the interaction data record is comprised of transferring an access code to the barrier assembly.

11. The non-transitory computer readable media of claim 7 wherein the automatic action is executed at the stopping position.

12. The non-transitory computer readable media of claim 7 wherein the automatic action is executed during movement in a vicinity of the barrier assembly.

13. A motor vehicle configured to operate in conjunction with a barrier assembly, comprising:
environment sensors collecting an environment data record from the motor vehicle;
an output device facilitating interaction with an interface device of the barrier assembly; and
a controller configured to 1) evaluate the environment data record to detect an approach to the barrier assembly, 2) determine a stopping data record comprised of a stopping position of the motor vehicle and a trajectory data record defining a trajectory from a current position of the motor vehicle to the stopping position, wherein the stopping position is configured to enable an interaction with the interface device, and 3) execute an automatic action during the approach to the barrier assembly to facilitate access to the barrier assembly, wherein the action is determined according to an interaction data record corresponding to the detected barrier assembly.

14. The motor vehicle of claim 13 wherein the controller is further configured to drive the motor vehicle autonomously on the trajectory to stop at the stopping position according to a control data record for controlling the motor vehicle from a current position of the motor vehicle to the stopping position.

15. The motor vehicle of claim 13 wherein the automatic action specified by the interaction data record is comprised of opening a window of the motor vehicle facilitating interaction by an occupant of the motor vehicle with the interface device of the barrier assembly.

16. The motor vehicle of claim 13 wherein the automatic action specified by the interaction data record is comprised of transferring an access code to the barrier assembly.

17. The motor vehicle of claim 13 wherein the automatic action is executed at the stopping position.

18. The motor vehicle of claim 13 wherein the automatic action is executed during movement in a vicinity of the barrier assembly.
